(19) United States
(12) Patent Application Publication
(10) Pub. No.: US 2008/0310429 A1
(43) Pub. Date: Dec. 18, 2008

(54) EQUIVALENT SWITCHING METHOD FOR TRANSMISSION DEVICES IN MPLS NETWORKS

(75) Inventor: Joachim Klink, Munich (DE)

Correspondence Address: BELL, BOYD & LLOYD, LLP, P.O. BOX 1135, CHICAGO, IL, 60690, US

(73) Assignee: Siemens Aktiengesellschaft, Muenchen (DE)

(21) Appl. No.: 12/135,815

(22) Filed: Aug. 28, 2008

Related U.S. Application Data
(63) Continuation of application No. 10/203,980, filed on Aug. 15, 2002.

(30) Foreign Application Priority Data
Feb. 15, 2000 (EP) 00103083.2

(51) Int. Cl. H04L 12/56

(52) U.S. Cl. 370/400

(57) ABSTRACT

In prior art, one of the problems of equivalent switching MPLS packets is that the transmission of MPLS packets is defined unidirectionally. The inventive method provides a solution to the problem in the form of a configuration which allows for bidirectional and 1:n unidirectional transmission (requiring a reverse LAN channel). Equivalent switching operations in the case of an error occurring when a working entity fails are administered in an efficient manner according to priority criteria and MPLS link information.

### CLAIM FOR PRIORITY

This application claims priority to International Application No. PCT/EP01/00337 which was published in the German language on Aug. 23, 2001.

### TECHNICAL FIELD OF THE INVENTION

The invention relates to a system for the protection switching of transmission devices in networks.

### BACKGROUND OF THE INVENTION

A method for the protection switching of transmission devices is known from German Patent Specification DE 196 36 016 C2. This method relates to transmission devices via which information is conducted in accordance with an asynchronous transfer mode (ATM). In this arrangement, a transmission device for the bi-directional transmission of digital signals is provided in which two switching systems acting as terminal stations are connected to one another via a multiplicity of operating links and one protection link. The two terminal stations in each case contain a monitoring device for detecting transmission disturbances. A switching system, which can be controlled by the monitoring device, connects a receiving device to the operating link in a first switching state and to the protection link in a second switching state.

One disadvantage of this method is that it exclusively relates to ATM transmission devices. In the Internet, information is supplied to the receiving subscriber via a multiplicity of network nodes which can be constructed as routers. Between the routers, MPLS networks can be arranged. However, MPLS networks are not considered in the known method.

### SUMMARY OF THE INVENTION

The invention discloses a system and method for protection switching in such a manner that information can be transmitted with great reliability via a multiplicity of network nodes even in the Internet.

In one embodiment of the invention, two oppositely directed unidirectional MPLS links are logically associated with one another in such a manner that the two oppositely directed MPLS links in each case connect the same switching systems. This makes it possible to implement both a bi-directional transmission and a 1:n unidirectional transmission (for which a return channel is also needed). Furthermore, one protection link is provided which is allocated to a multiplicity of operating links. The MPLS packets of the disturbed operating link are forwarded via this protection link in accordance with priority criteria. The switching-through by the receiving switching system is then effected with the aid of an MPLS connection number. This is associated with the advantage that the MPLS connection can be maintained in the case of a fault.

### BRIEF DESCRIPTION OF THE DRAWINGS

In the text which follows, the invention will be explained in more detail with reference to an exemplary embodiment, in which:

FIG. 1 shows an MPLS network linked in to the Internet.

FIG. 2 shows the method according to the invention for the bi-directional transmission of MPLS packets in a 1:n structure.

FIG. 3 shows an embodiment according to the invention in a 1:1 structure.

FIG. 4 shows an embodiment according to the invention in a 1+1 structure.

FIG. 5 shows the priorities used in accordance with which the protection switching is effected.

### DETAILED DESCRIPTION OF THE PREFERRED EMBODIMENTS

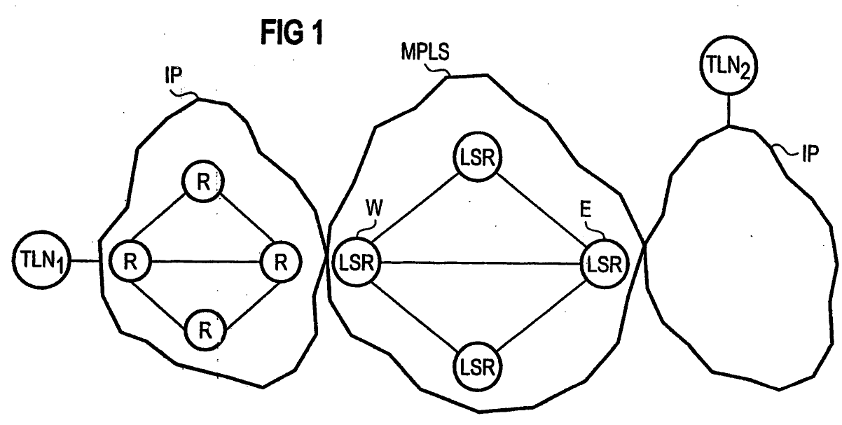

FIG. 1 shows by way of example how information coming from a subscriber TLN1 is supplied to a subscriber TLN2. The transmitting subscriber TLN1 is connected to the Internet network IP through which the information is conducted in accordance with an Internet protocol such as, e.g., the IP protocol. This protocol is not a connection-oriented protocol. The Internet network IP exhibits a multiplicity of routers R which can be intermeshed with one another. The receiving subscriber TLN2 is connected to a further Internet network IP. Between the two Internet networks IP, an MPLS (Multiprotocol Packet Label Switching) network is inserted through which information is switched through in a connection-oriented manner in the form of MPLS packets. This network exhibits a multiplicity of mutually intermeshed routers. In an MPLS network, these can be so-called label switched routers (LSR). One of the routers is designated as transmitting device W and another one is designated as receiving device E. MPLS packets in each case have a header and an information section. The header is used for accommodating connection information whereas the information section is used for accommodating user information. The user information used is IP packets. The connection information contained in the header is arranged as MPLS connection number. However, this has validity in the MPLS network. When thus an IP packet from the Internet network IP penetrates into the MPLS network, the header valid in the MPLS network is appended to it. This includes connection information which predetermines the path of the MPLS packet in the MPLS network. When the MPLS packet leaves the MPLS network, the header is removed again and the IP packet is routed further as determined by the IP protocol in the Internet network IP following it.

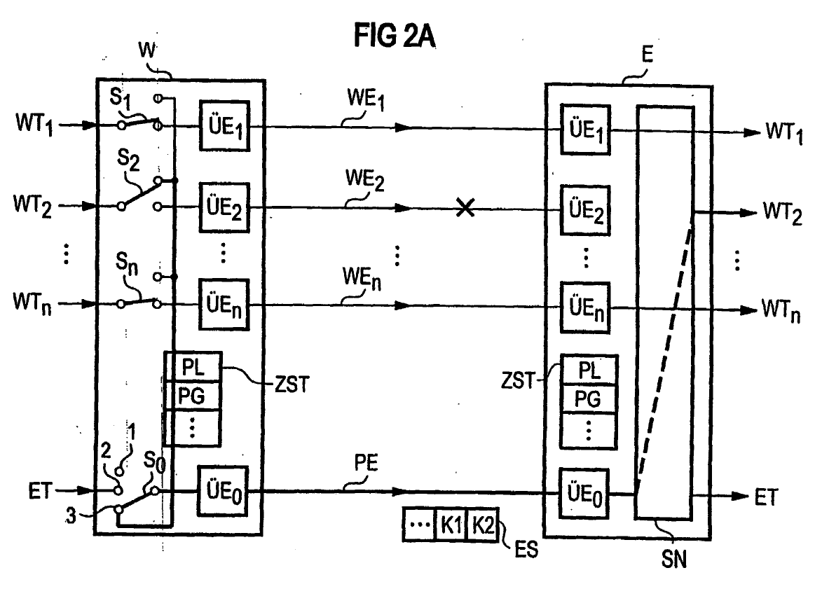

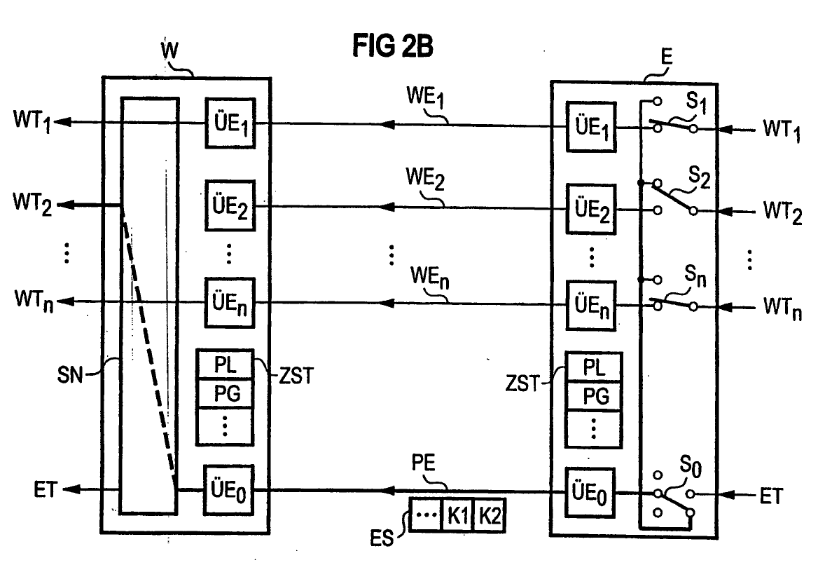

FIG. 2 shows by way of example two nodes of an MPLS network which are in each case arranged as switching system W, E. In the present exemplary embodiment, it is assumed that these switching systems are MPLS cross-connect switching systems. Using switching systems of such a construction, however, does not signify a restriction of the invention and other switching systems such as, e.g. ATM switching systems can be similarly used. In FIG. 2, then, MPLS (Multiprotocol Label Switched Packets) packets are to be transmitted from the switching system constructed as label switched router W toward the switching system constructed as label switched router E.

FIG. 2a shows the transmission of MPLS packets from the label switched router W toward the label switched router E, whereas FIG. 2b discloses the return direction of this connection. FIGS. 2a and 2b together represent a bi-directional arrangement. According to definition, however, connections for MPLS networks are only defined unidirectionally in principle. A bi-directional arrangement is achieved by logically associating two oppositely directed unidirectional MPLS connections (LSPs—label switched paths) with one another. This assumes that the two oppositely directed connections in each case connect the same switching systems (e.g. W and E in FIGS. 2a and 2b or also other switching systems located in between these). This should be ensured when setting up the two connections.

MPLS packets in each case have a header and an information section. The header is used for accommodating connection information whereas the information section is used for accommodating user information. The user information used is IP packets. The connection information contained in the header is constructed as MPLS connection number. However, this has validity in the MPLS network. When thus an IP packet from the Internet network IP penetrates into the MPLS network, the header valid in the MPLS network is appended to it. This includes connection information which predetermines the path of the MPLS packet in the MPLS network. When the MPLS packet leaves the MPLS network, the header is removed again and the IP packet is routed further as determined by the IP protocol in the Internet network IP following it. The label switched routers W, E are connected to one another via operating links WE₁ . . . WEₙ (WORKING ENTITY) and one protection link PE (PROTECTION ENTITY). Furthermore switching systems S₀ . . . Sₙ (BRIDGE) are shown via which the incoming MPLS packets and the associated operating links WE₁ . . . WE₁ are transmitted toward the label switched router E. Furthermore, FIG. 2 shows selection devices SN, the task of which is to supply the MPLS packets transmitted via the operating links WE₁ . . . WEₙ to the output of the label switched router E. According to the present exemplary embodiment, the selection devices SN are constructed as switching network. The switching network SN is arranged both in the label switched router W and in the label switched router E.

Furthermore, monitoring devices ÜE₀ . . . ÜEₙ (PROTECTION DOMAIN SINK, PROTECTION DOMAIN SOURCE) which monitor the state or the quality of the MPLS packets transmitted via the operating links WE₁ . . . WEₙ are shown in the two label switched routers W, E. For example, the MPLS packets of the connection with the number 1 WT₁, before they are transmitted via the operating link WE₁ toward the label switched router E, are provided with control information in the monitoring device ÜE₁ of the label switched router W, which control information is taken and checked by the monitoring device ÜE₁ of the receiving label switched router E. Using this control information, it is then possible to determine whether the transmission of the MPLS packet has been correct or not. In particular, a total failure (SIGNAL FAIL FOR WORKING ENTITY) of one of the operating links WE₁ . . . WEₙ can be determined here. Similarly, degradations in the transmission quality (SIGNAL DEGRADE) however can also be determined by using known methods.

The monitoring devices ÜE₀ . . . ÜEₙ terminate the operating links WE₁ . . . WEₙ at both ends. Other monitoring devices ÜE₀ . . . ÜEₙ are arranged at both ends of the protection link PE. In the case of a fault, this is to be used as transmission link for the operating link WEₓ taken out of operation. Furthermore, protection switching protocols E are transmitted via this link so that the integrity of the protection link has top priority.

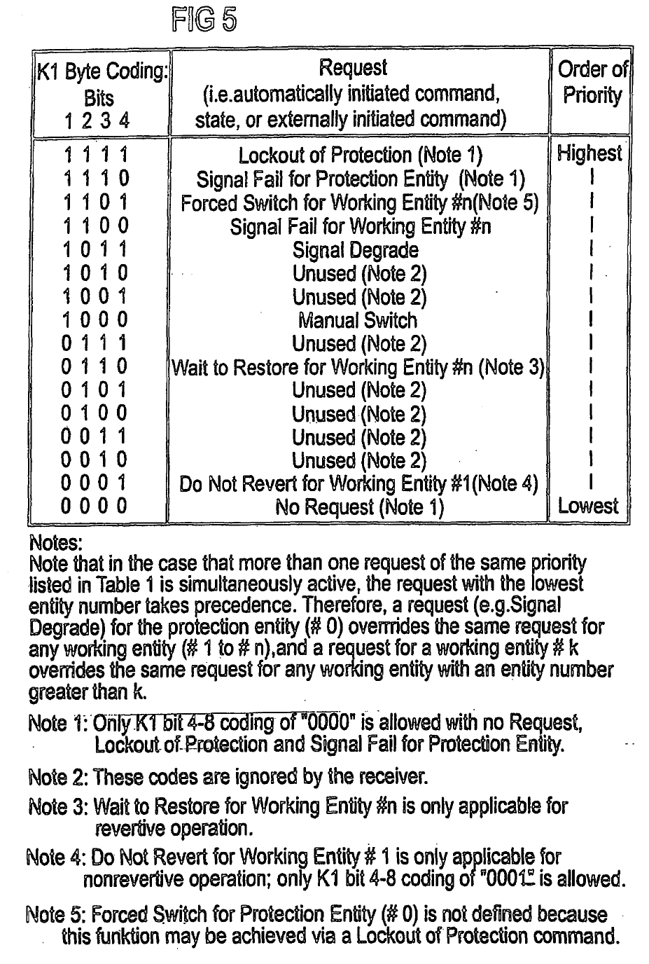

In each of the label switched routers W, E, central controllers ZST are also arranged. These in each case include priority tables PG, PL. The priority tables PL are local priority tables in which the status and priority of the local label switched router W is stored. The priority tables PG are global priority tables which contain status and priority of the local and the remaining label switched router E. The introduction of the priorities has the result that when a number of protection switching requests occur at the same time, the operating link is specified which is to be protection-switched. Similarly, the protection switching requests are prioritized in the priority tables. Thus, for example, there is a high-priority request from a user. Since this protection switching request is assigned a high priority, it is thus controlled with preference. A protection switching request controlled by one of the operating links, which is assigned a lower priority, is thus rejected. The individual priorities are shown in FIG. 5.

The central controllers ZST of the label switched routers W, E exchange information in a protection switching protocol ES. This protocol is transmitted via the protection link PE and taken by the associated monitoring device U of the respective receiving label switched router, and supplied to the relevant central controller ZST. Furthermore, the central controller ZST ensures that the switching systems S₀ . . . Sₙ are appropriately controlled in the case of a fault.

The protocol ES includes information K1, K2. K1 is information with respect to the protection switching request generated, whereas K2 is information with respect to the current states of the switching systems. The protocol ES is in each case exchanged between the two label switched routers W, E when a protection switching request is generated. In an embodiment of the invention, it is provided to transmit the protocol ES cyclically between the two label switched routers W, E.

In the text which follows, the performance of the invention is explained in greater detail with reference to FIG. 2. As already explained, FIG. 2a shows the transmission of the MPLS packets from the label switched router W to the label switched router E via the operating links WE₁ . . . WEₙ; and FIG. 2b is the associated opposite direction (bi-directional transmission). It is then initially assumed that the operating links WE₁ . . . WEₙ are still intact and correctly transmit the incoming MPLS packets.

The MPLS packets belong to a multiplicity of connections WE₁ . . . WEₙ. The individual connections are distinguished by means of the MPLS connection number entered in the packet header of the MPLS packets.

In this operating case, the switching systems S₁ . . . Sₙ of the label switched router W are switched such that the MPLS packets are directly supplied to the monitoring devices ÜE₁ . . . ÜEₙ. In the latter, the control information already discussed is applied to the MPLS packets and they are supplied via the operating link WE₁ . . . WEₙ in question to the monitoring devices ÜE₁ . . . ÜEₙ of the receiving label switched router E, where the accompanying control information is checked and fault case is determined if need be. If the transmission has been correct, the MPLS packets are supplied to the switching network SN, where the MPLS connection information is evaluated and the MPLS packet is forwarded in accordance with this evaluation via the appropriate output of the switching network SN into the subsequent network.

The protection link PE can remain unused during this time. If necessary, however, it is also possible to supply special data (EXTRA TRAFFIC) to the label switched router E during this time. In this case, the switching system S₀ of the label switched router W assumes the position 2 (FIG. 2a). The special data are also transmitted in MPLS packets. The monitoring device ÜE₀ of the label switched router W applies control information to these MPLS packets carrying the special data in the same manner as has already been described in the case of those via the operating links WE₁ . . . WEₙ.

The special data transmitted via the protection link can also be low-priority traffic which is transmitted in the network when there are sufficient resources available. The low-priority traffic is then automatically displaced by high-priority traffic being protection-switched in this case. In this case, the special data are not displaced in the protection switching case by switching the switching system S₀ in FIG. 2, but by prioritizing the high-priority traffic with respect to the low-priority special data in each direction of transmission.

In the text which follows, it is now assumed that the operating link WE₂ has failed. This is determined by the monitoring device ÜE₀ . . . ÜE₂ associated with this operating link WE₂, of the receiving label switched router E. The protection switching request K1 is then transmitted to the relevant central controller ZST and is stored there in the local priority table PL and in the global priority table PG. As determined by the priorities stored in the global priority table PG, it is then determined whether requests with higher priority are still present. This could be, for example, the switch-over request of the user already discussed (FORCED SWITCH FOR WORKING ENTITY). Even when other cases of disturbance occur at the same time, such as, for example, of the operating link WE₁ the protection switching of this operating link would have to be treated with preference since this operating link is assigned a higher priority. In this case, a request with higher priority is dealt with first. The priorities stored in the local and global priority table PL, PG are shown in FIG. 5.

If there are no requests with higher priority, the switching system S₂ of the label switched router E is driven into the remaining operating state, as shown in FIG. 2b. Thereafter, the protection switching protocol ES is then supplied to the label switched router W via the protection link PE. This protection switching protocol includes the information K1 and K2 already discussed. The essential factor is that the local priority logic defines the arrangement of the information K1, and the global priority logic defines the position of the switching system Sₒ.

The monitoring device ÜE₀ of the label switched router W then takes over the protection switching protocol ES and supplies it to the central controller ZST arranged here. If no further requests with higher priority are present in the global priority table PG, the switching system S₂ is also correspondingly driven and set in this case. Furthermore, the switching system S₀ of the label switched router W is also switched over. The new status of the two switching systems S₀, S₂ is acknowledged to the label switched router E and updated in the global priority table PG there. The MPLS packets of the connection WT₂ are thus supplied to the label switched router E via the protection link PE.

The selection device SN of the receiving label switched router E is preferably constructed as switching network. The MPLS packets conducted via the protection link PE are supplied to this switching network. The MPLS connection number (label value) here is taken from the packet header, evaluated and routed through the switching network. Thus, in this case, no switching systems are driven. Since these connections are a bi-directional connection, it is also necessary to ensure the transmission of the MPLS packets in the reverse direction. According to FIG. 2b, this is done in the same manner as has been described above for the transmission of the MPLS packets from the label switched router W toward the label switched router E.

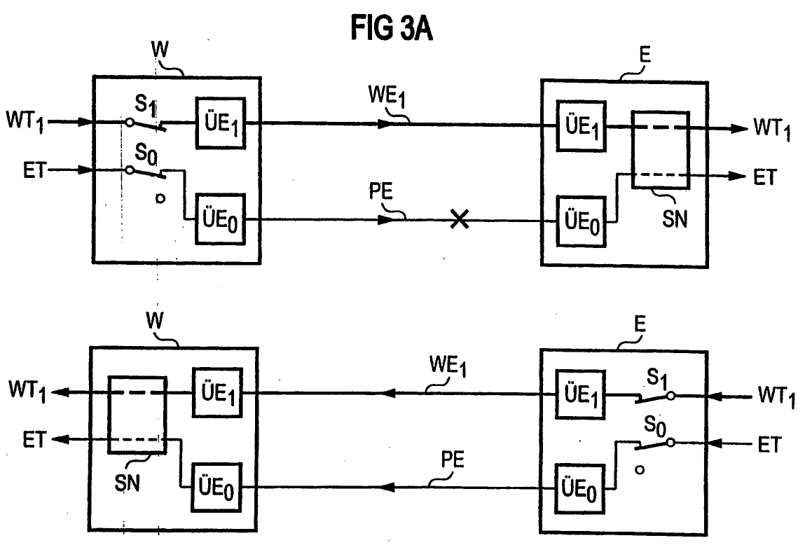

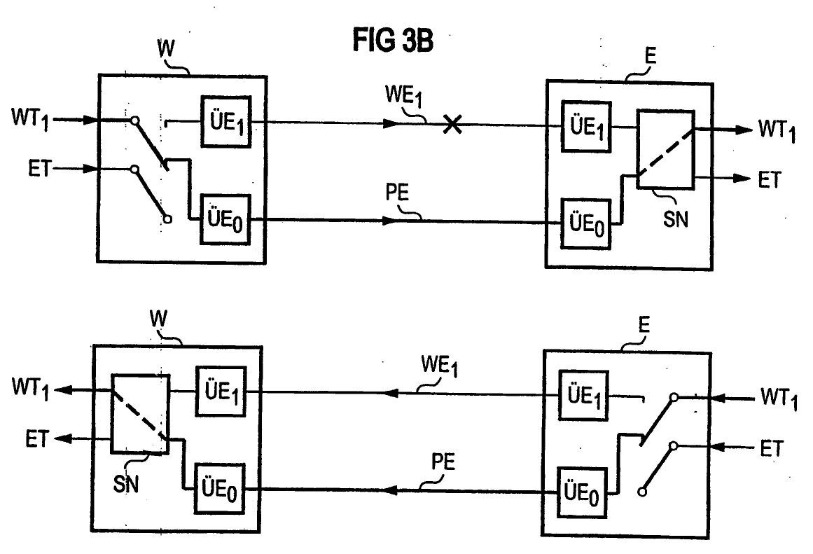

According to the exemplary embodiment described, a 1:n structure has been assumed. This means that one protection link is available for n operating links. A special case is thus given when n=1 holds true. In this case, a 1:1 structure is thus used. The corresponding conditions are shown in FIG. 3.

In this case, the selection device is constructed as a switching network so that switching through takes place as determined by the MPLS connection number. The switching systems according to FIG. 3 also include central controllers (not shown) with local and global priority tables.

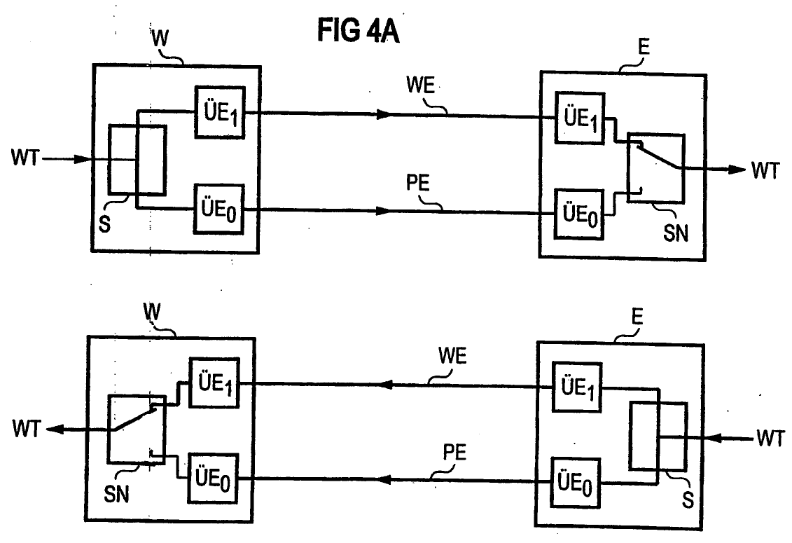

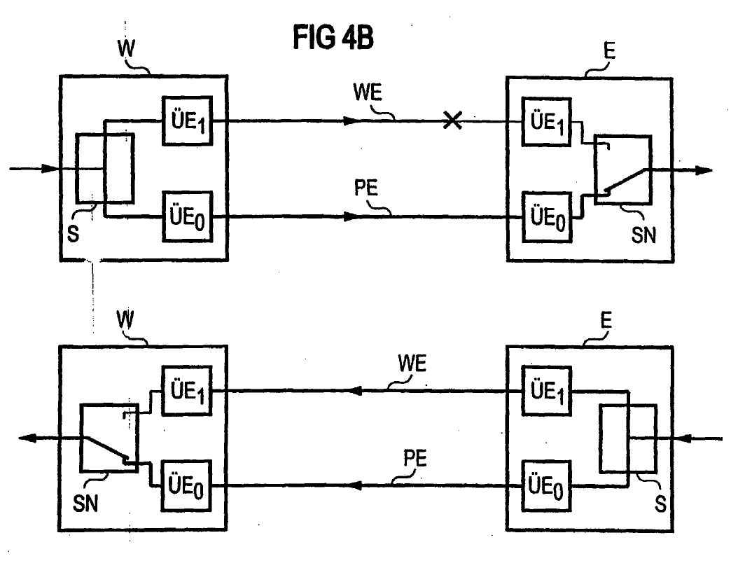

FIG. 4 shows another embodiment of the invention. This involves a 1+1 structure. This structure is obtained from the 1:n structure in that the switching systems S are permanently set and can no longer be controlled via the central controllers ZST. Thus, the MPLS packets are conducted both via the operating link WE and the protection link PE also in the faultless operating case. The selection device SN is not constructed as a switching network but as a switching system in this case. The protection switching protocol ES assumes a simpler form in this case. The information K2 in this case describes the status of the selection device. Whenever the switching systems S₀ . . . Sₙ were controlled in the case of the 1:n structure, the selection device SN is controlled instead in the case of the 1+1 structure.

The previously described embodiments of the invention are bi-directional in the sense that both user data and protocol communication takes place in both directions. In another embodiment of the invention, a 1:n unidirectional operation is possible. In this arrangement, the user data are transmitted in one direction (e.g. according to the arrangement in FIG. 2a). In the reverse direction (cf. FIG. 2b), no user data are transmitted. However, the protection link (PE in FIG. 2b) continues to be present in the reverse direction, since the protocol communication is still needed (as in the bi-directional case) so that the switching systems S₀ to Sₙ in FIG. 2a can be controlled.

A special case of the unidirectional 1:n structure is given when n=1 holds true (see also FIG. 3).

It has hitherto been assumed that each MPLS connection is individually monitored and protection switched. Failures and disturbances can thus be taken into consideration connection-individually such that when a single connection fails or its transmission quality is degraded, it can be protection switched.

In various embodiments of transmission devices of this type, however, many individual connections are frequently conducted via the same physical path (e.g. an optical fiber) between transmission devices. In the case of an interruption of this path (e.g. a fiber break), individual connections are affected by a single failure. Failures of this type predominate in practice compared with failures relating to individual connections. In particular, a protection switching protocol would have to be entered in the priority table PL for each interrupted individual connection in this case.

In an embodiment of the invention, it is therefore provided to jointly protection switch a multiplicity of individual connections by means of group protection switching.

For this purpose, MPLS connections conducted via the same physical path are logically combined to form one group. Furthermore, two protection switching connections are generated for this group. The first one of these protection switching connections is conducted via the operating link WE (MPLS protection switching LSP (Label Switched Path)), as a result of which it is conducted via the same physical path between the label switched routers W and E as associated individual connections. The second one of these protection switching connections is set up via the protection link PE.

In the group protection switching method, these two protection switching connections are now monitored for failures and disturbances in the monitoring devices ÜE₁ . . . ÜE₀. The individual connections are no longer monitored. In the case of a protection switching request, the priority-controlled protection switching decision is taken in the priority logic PL as before. In the protection switching case, however, individual connections belonging to a group are jointly switched over by the switching system SN. It is then only necessary to run a single protection switching protocol via the protection link PE.

The advantages of this is that a multiplicity of individual connections are monitored, and can be protection switched, by a single protection switching connection and a single protection switching protocol in order to thus be able to respond appropriately to the fault cases occurring most frequently in practical operation. Furthermore, only one protection switching protocol is entered in the priority table PL.

The operating and protection links WE and PE should be set up before start-up. For this purpose, connections should be set up (configured) between the label switched routers W and E and possibly at intermediate transmission devices.

These connections are usually set up by TMN (Telecommunication Network Management), but it can also be done by means of an MPLS signaling protocol. For this purpose, the path of the operating or protection link is specified by signaling in this case. In addition, the signaling protocol is used for reserving bandwidth in the transmission devices, so that the transmission of the information via the operating or protection link is ensured.

1. A method for the protection switching of transmission devices for transmitting MPLS packets, comprising:
arranging switching systems between a transmitting and a receiving switching system which transmitting and receiving switching system terminate a transmission section formed from a multiplicity of operating links and which exchange information over the multiplicity of operating links;
arranging monitoring devices; at the end of an operating link;
determining a disturbance of the operating link; and
providing a protection link between the transmitting and receiving switching systems,
such that in the case of a disturbance on one of the operating links information transmitted is forwarded according to a priority criteria, such that in the case of a simultaneous occurrence of a number of protection switching requests, determination is made about which operating link is to be protection switched, and according to connection information imparted by the information, wherein
the information is linked into MPLS packets, such that two oppositely directed unidirectional MPLS connections are logically associated with one another, the two oppositely directed MPLS connections in each case connecting the same switching systems.

2. The method as claimed in claim 1, wherein a priority is allocated to the operating links and to the protection link.

3. The method as claimed in claim 1 wherein in the protection switching case, a protection switching request is generated to which other priorities are assigned.

4. The method as claimed in claim 1, wherein the logical connection information is the MPLS connection number.

5. The method as claimed in claim 1, wherein priority tables are provided in which the priorities are defined.

6. The method as claimed in claim 1, wherein the protection switching is effected by driving a switching system in the transmitting switching system and by using a selection device arranged in the receiving switching system.

7. The method as claimed in claim 1, wherein the selection device is constructed as a switching network.

8. The method as claimed in claim 1, wherein group protection switching is provided for MPLS connections conducted via the same physical path and are logically combined to form a group, at least two protection switching connections are generated for the group, one of these protection switching connections being set up via an operating link and another one of thee protection switching connections being set up via the protection link.

9. The method as claimed in claim 1, wherein in the case where group protection switching is provided, the monitoring devices monitor the at least two protection switching connections.

10. The method as claimed in claim 1, wherein the connections conducted via the at least one operating link and the connections conducted via the protection link are set up via an MPLS signaling protocol which reserves bandwidth in the transmission devices and specifies the path of the operating link and of the protection link.

11. The method as claimed in claim 1, wherein data are transmitted via the protection link in times free of operating disturbances.

12. The method as claimed in claim 11, wherein the data are arranged as low-priority traffic which is automatically displaced in the case of protection switching of the high-priority traffic.

13. The method as claimed in claim 1 wherein when a protection switching request arrives in the receiving switching system, a protection switching protocol is generated which is supplied once to the remain switching system via the protection link (PE).

14. The method as claimed in claim 1 wherein failure and degradation of an operating link are determined in the monitoring device of the receiving switching system.

15. The method as claimed in claim 1, wherein the switching system can be permanently set.

16. The method as claimed in claim 1, wherein the switching systems are constructed as cross-connect switching systems.
